(19) United States
(12) Patent Application Publication
(10) Pub. No.: US 2012/0275510 A1
(43) Pub. Date: Nov. 1, 2012

(54) SCALING SIGNAL QUALITY WITH CHANNEL QUALITY

(75) Inventors: Szymon Kazimierz Jakubczak, Cambridge, MA (US); Dina Katabi, Cambridge, MA (US); Rahul Shankar Hariharan, Cambridge, MA (US)

(73) Assignee: Massachusetts Institute of Technology, Cambridge, MA (US)

(21) Appl. No.: 12/951,222

(22) Filed: Nov. 22, 2010

Related U.S. Application Data
(60) Provisional application No. 61/264,439, filed on Nov. 25, 2009.

(51) Int. Cl. H04B 1/66; H04L 27/06; H04N 7/26; H04L 27/04; H04B 15/00

(52) U.S. Cl. 375/240.02; 375/295; 375/285; 375/240; 375/340; 375/E07.026

(57) ABSTRACT

A communication system, which may be applied to video communication, transmits a single stream that each of multiple multicast receivers decodes to a video quality commensurate with its channel quality. An advantage of one or more aspects relates to mobile receivers by avoiding the catastrophic glitches that occur today in the presence of channel variations due to mobility.

### CROSS-REFERENCE TO RELATED APPLICATIONS

This application claims the benefit of U.S. Provisional Application No. 61/264,439, filed Nov. 25, 2009, which is incorporated herein in its entirely by reference.

### STATEMENT AS TO FEDERALLY SPONSORED RESEARCH

This invention was made with government support under contract numbers 6917552 and 6914683 awarded by DARPA. The government has certain rights in the invention.

### BACKGROUND

This description is related to a communication approach in which signal quality scales with channel quality. In some examples, this approach is applied to video, audio, or sensor data communication in which the content is degradable, for instance, by expressing the content with different degrees of quantization.

Wireless video is becoming increasingly important, driven by user demand for mobile TV, media sharing, and the broadcast of sporting events, lectures, and promotional clips, in universities, malls, and hotspots. Many of these applications involve multicast and mobility, and hence present a significant challenge to conventional wireless design. With multicast, different receivers experience different channel qualities (e.g., Signal-to-Noise Ratios, SNRs). As a result the source faces conflicting requirements: it can transmit its stream at a high bitrate but reach only nearby receivers, or it can reach all receivers by transmitting at a low bitrate which reduces everyone to the channel quality of the worst receiver. With mobility, the channel quality can exhibit large unpredictable variations. As a result, the source can either pick a conservative choice of bitrate and error correcting codes or risk catastrophic glitches in the received video when the instantaneous channel quality drops below the quality anticipated by the source. The common problem however underlying both cases is that the source is unable to select a single video stream that works simultaneously across multiple different and potentially unknown channel qualities.

Past work includes approaches that try to address this problem in the context of wired multicast, but the solutions do not generally extend to the wireless environment. For instance, Multiple Resolution Coding (MRC) divides the video into a base layer and multiple enhancement layers. The base layer is necessary for decoding the video, while the enhancement layers improve its quality. The MRC approach is useful for wired multicast, where a receiver with a congested link can download only the base layer, and avoid packets from other layers. With wireless, all layers share the medium. The existence of the enhancement layers reduces the bandwidth available to the base layer, and further worsens the performance of poor receivers.

### SUMMARY

In one aspect, in general, an approach to delivering degradable content (i.e., content that can be expressed at different compression or quantization levels) over a channel such that the signal samples transferred over the channel are monotonically related to the original content values, and hence perturbations of the transferred signal translates into monotonically related perturbations of the original content values.

In another aspect, in general, an approach to a wireless video communication aims to avoid limitations of prior approaches by having the source transmit a single stream that each multicast receiver decodes to a video quality commensurate with its channel quality. An advantage of one or more aspects is that mobile receivers avoid the catastrophic glitches that occur today in the presence of channel variations due to mobility.

In another aspect, in general, an encoding technique enables a source to broadcast a single stream without fixing a bitrate or a video code rate and lets each receiver decode the stream to a video quality commensurate with its channel quality. The encoding works by ensuring that the coded video samples transmitted on the medium are linearly related to pixel values. Since channel noise perturbs the transmitted coded signal samples, a receiver with high SNR (i.e., low noise) receives coded samples that are close to the transmitted coded samples, and hence naturally decodes pixel values that are close to the original values. It thus recovers a video with high fidelity to the original. A receiver with low SNR (i.e., high noise), on the other hand, receives coded video samples that are further away from the transmitted coded samples, decodes them to pixel values that are further away from the original values, and hence gets a lower fidelity image. Thus, the technique provides graceful degradation of the transmitted image for different receivers, depending on the quality of their channel. This is unlike the conventional design, where the transmitted coded signal samples do not preserve the numerical properties of the original pixels. As a result, when a bad channel causes even a small perturbation in the received coded signal, e.g., a bit flip, it results in an arbitrarily large error in pixel luminance.

In another aspect, in general, a video communication system ensures that the coded digital samples transmitted by a PHY layer are linearly related to pixel values, so that a small perturbation on the channel produces a small perturbation in the video. This approach is in contrast to certain conventional designs that map real-value video pixels to finite field codewords, i.e., bit sequences, code them for compression and error protection, and map them back to real-value digital samples that are transmitted on the channel. Such a conventional process of mapping to bits however destroys the numerical properties of the original pixels. As a result, small channel errors, e.g., a bit flip, can cause large deviations in the pixel values.

In another aspect, in general, in a video communication system, both video and the transmitted digital signal are expressed as real numbers, and a transmitter codes the video for compression and error protection directly in the real field. In some examples, a linear codec is used, and the coded values can be made to scale with the original pixel. The output of the codec can then be transmitted directly over OFDM as the I and Q components of the digital signal. Since the transmitted values are linearly related to the original video pixels, the noise in the channel, which perturbs the transmitted signal, translates to corresponding deviations in video pixels. When the transmitted signal is received with higher SNR (i.e., it is less noisy), the video is naturally received at a higher resolution.

In another aspect, in general, a method for communicating an input signal includes processing each of a series of parts of the input signal. For each part, the processing includes forming a plurality of component values for components for the part of the signal. The plurality of component values are partitioned into a set of sections, (which in some examples may be referred to as “chunks”) of component values. A plurality transmission values are formed from the plurality of component values (130). The plurality of transmission values including a set of sections (which in some examples may be referred to as “slices”) of transmission values. Each section of transmission values includes a combination of multiple sections of component values. The transmission values are sufficient to reconstruct some or all of the component values). The processing for each part further includes forming a series of transmission units (which in some examples correspond to packets) from the transmission values, each transmission unit including a plurality of modulation values represents at least one section of transmission values. The modulations values of the transmission units are modulated to form a transmission signal for transmission over a communication medium, each modulation component of the transmission signal corresponding to a different one of the modulation values, and a magnitude of each modulation component being a monotonic function of the corresponding modulation value such that a degree of degradation of the component values represented in the transmission signal is substantially continuously related to a degree of degradation of the modulation components of the transmission signal.

Another aspect includes, in general, a method for receiving the transmission units, which may have been degraded by additive degradation and/or loss of some of the transmission units, and reconstructing an estimate of the input signal.

Another aspect includes, in general, a system for forming the transmission units from the input signal. Yet another aspect includes, in general, a system for receiving the transmission units, which may have been degraded by additive degradation and/or loss of some of the transmission units, and reconstructing an estimate of the input signal.

In another aspect, in general, a method for communicating over a shared access medium includes providing an interface for accepting transmission units each including a data payload from a communication application, and accepting an indication whether a data payload of the transmission unit should be transmitted using a digital coding of the data payload or using a monotonic transformation of values in the data payload to magnitudes of modulation components in a transmission signal. A signal representation of the transmission units is formed according to accepted indications, and a plurality of transmission units are transmitted onto the shared medium, including transmitting at least some of said units using a digital coding of the data payload of the unit and at least some of said units using a monotonic transformation of values to modulation components.

Aspects may include on or more of the following features.

At least some of the transmission units are not received at the first receiver, and the estimate of the signal is reconstructed using the estimates of the transmission values in the received transmission units.

A second receiver may be included for demodulating the transmission signal after transmission over the communication medium to form second estimates the transmission values, the second estimates of the transmission values representing substantially greater error than the first estimates formed at the first receiver. The component values for the components of each of the plurality of parts of the signal are estimated from the estimated transmission values, and an estimate of the signal is reconstructed from the estimated component values, the estimate of the input signal representing substantially greater error than the estimate formed at the first receiver.

The transmission signal may be received at a plurality of receivers. Each received signal exhibits a different degree of degradation. An estimate of the signal is formed at each receiver. The estimate at each receiver exhibits an error that is substantially continuously related to the degree of degradation of the received signal.

Each transmission value in a section of transmission values is a monotonic function of component values in multiple sections of component values. For example, each transmission value in a section of transmission values is a linear function of component values in multiple sections of component values.

Forming the plurality transmission values from the plurality of component values includes scaling the component values in each section of component values according to a scale factor associated with that section, and applying an orthogonal transform to the scaled component values. The orthogonal transform can include a Hadamard transform. Forming the plurality transmission values is such that each section of transmission values has a substantially equal power measure. Forming a plurality of transmission values from the plurality of component values includes forming scaled component values by scaling the component values in each section according to a scale factor determined according to a power measure associated with that section. The sections of scaled component values are combined to form the sections of transmission values. The sections of scaled component values have different power measures.

The scaled factor that is determined according to a power measure associated with a section is inversely proportional to a fourth root of a variance of the component values in the section.

Forming a series of transmission units from the transmission values includes determining the modulation values in each transmission unit to have substantially identical statistical characteristic. Forming a transmission unit includes applying an orthogonal transformation to transmission value to form the modulation values of the transmission unit. Forming the plurality transmission values from the plurality of component values includes forming ancillary data required for reconstructing the component values from the sections of transmission values. The ancillary data represents scale factors for the sections of the component values, and forming the transmission values includes scaling each section of the component values and applying an orthogonal transform to the scaled component values to determine the transmission values.

The input signal includes a series of image frames, and each part of the signal includes a frame of the series. The components of the part of the signal include Discrete Cosine Transform (DCT) components. Each frame includes a plurality of blocks, and the DCT components include DCT coefficients of the blocks of the image. Each section of component values for a part of the input signal can include a DCT coefficient value for multiple blocks of the image and on DCT coefficient. Each part of the signal can include a plurality of frames of the series.

Components of the part of the signal include coefficient values of a three-dimensional orthogonal transform of the part of the signal. The three dimensions of the transform include a time dimension and two spatial dimensions. The orthogonal transform includes a three-dimensional DCT. Each section of component values for a part of the input signal includes a transform coefficient value a contiguous range of temporal and spatial frequency coefficients. Each section of component values consists of a coefficient for a single temporal frequency.

Forming the plurality of transmission values includes scaling component values for a same component in different parts of the signal according to a power measure of the component values. The distribution of the component values includes a sample power measure over a plurality of parts of the signal. Forming the component values includes forming the component values such that component values corresponding to different components are substantially uncorrelated. Forming the transmission values includes applying an orthogonal transformation to the component values for components of each part of the signal. Forming the transmission values includes distributing the component values to transmission values according to a sequence. The sequence includes a pseudo-random sequence known to a receiver of the transmission signal.

Forming the transmission values and assembling the transmission values into transmission units is such that a power measure of each transmission unit is substantially equal to the power measure for the other transmission units. Forming the transmission units is such that an impact of loss of any packet has a substantially equal impact on reconstruction error at a receiver. The impact of loss of any packet has a substantially equal impact on a mean squared error measure of the reconstructed signal.

Modulating the transmission values includes applying an Orthogonal Frequency Division Multiplexing (OFDM) technique in which each transmission value corresponds to a modulation component including a quadrature component of a frequency bin of the transmission signal. Forming the transmission values includes selecting a number of transmission values according to an available capacity of the communication medium for transmission of the modulated signal. Forming the transmission values includes selecting a number of transmission values according to a degree of degradation of the modulated signal. The transmission medium can include a shared access wireless medium.

Aspects may have one or more advantages and/or address one or more technical problems described below.

A joint video-physical layer (PHY) architecture can provide an advantage over existing wireless systems that use a video codec for compression and a PHY layer code for error protection. Having a PHY codec that is unaware of the video pixels can prevent a transmitter from achieving a goal of making the transmitted coded samples linearly related to the pixel values. Thus, by using the joint architecture, the video codec provides both compression and error protection, and the PHY simply transmits the codewords generated by the video codec.

A transmitter does not require receiver feedback, bitrate adaptation, or codec rate adaptation, yet can match the optimal MPEG-4 system, when the latter requires receiver feedback, bitrate adaptation, and codec rate adaptation.

For a diverse multicast group, the approach can improve the average receiver's PSNR by up to 7 dB over MPEG-4, and 8 dB over MRC. Results confirm that MRC is unsuitable for wireless environments because the presence of the enhancement layer reduces the medium time available to the base layer, but the improvement in video quality provided by the enhancement layer does not offset the resulting reduction in the performance of the base layer.

With a single mobile receiver, unlike MPEG-4, the approach can eliminate video glitches caused by reduction in channel SNR.

In comparison to MPEG-4, whose PSNR drops drastically by as much as 20 dB, at a loss rate as low as 1%, the approach's PSNR can remain high and drops by only 3 dB, even when the packet loss rate is as high as 10%.

The design can unify inter- and intra-frame coding, accounting both for correlations within a frame, and between frames, without requiring motion compensation and differential encoding.

The approach is highly robust to packet losses. It ensures that each packet contributes equally to reconstruction of pixel values across a group of pictures (GoP), so that the loss of a single packet does not create a patch in the video but rather smoothly distributes over all pixels.

Instead of requiring the source to pick an 802.11 bitrate and video resolution before transmission, the receiver can decode a video whose rate and resolution are commensurate with the observed channel quality after reception. This approach is beneficial for multicast and mobile wireless receivers, whose channels differ across time and space. Empirical results from a prototype show that the approach can achieve the best of two worlds, i.e., in scenarios where it is easy to find the best bitrate, (e.g., a single static receiver), the approach's video quality is comparable to the existing design. However, when there is no single good bitrate or the choice is unclear, (e.g., fast mobility or multicast), a significantly higher video quality is delivered.

The application of the methods or systems identified above in transferring any pixel related values including pixels' luminance or chroma values.

The use of any of the methods or systems identified over in transferring video over wired channels including cable modem channels or DSL.

Yet other aspects include, in general, software including instructions stored on computer readable medium for implementing any of the system or methods identified above.

Yet other aspects include, in general, the use of any of the systems or methods identified above in the transfer of degradable content including audio and sensor data over any channel wireless or wired.

### DESCRIPTION OF DRAWINGS

FIG. 1 is a diagram that illustrates transformation from an input signal to communication packets.

FIG. 2 is a diagram that illustrates modulation of communication packets.

FIG. 3 is a diagram that illustrates a first embodiment of a signal communication approach.

FIG. 4 is a diagram that illustrates a second embodiment of a signal communication approach.

FIG. 5A is a diagram of a transmitter.

FIG. 5B is a diagram of a receiver.

FIGS. 6A-C are diagrams that illustrate the transformation and segmentation of a group of pictures.

FIG. 7A is a diagram that illustrates a digital quadrature modulation scheme.

FIG. 7B is a diagram that illustrates an analog quadrature modulation scheme.

FIG. 8 is a graph that plots video quality as a function of receiver signal to noise ratio.

FIG. 9 is a graph that shows a video multicast to two receivers with different signal to noise ratios.

FIG. 10 is a graph that plots the average peak signal to noise ratio across receivers in a multicast group as a function of the signal to noise range in the group.

FIGS. 11A-C compare the video quality of MPEG-4 and an example of the present method under mobility. FIG. 11A is a graph PSNR versus frame index as a receiver moves away from the video source. FIGS. 11B and 11C show a corresponding video frames in present approach and MPEG-4, respectively.

FIG. 12 is a graph that plots peak signal to noise ratio in relation to a percentage of lost packets.

FIG. 13 is a graph that plots video quality as a function of channel errors.

FIG. 14 is a graph that plots video quality as a function of compression level.

### DESCRIPTION

### 1 Overview

A number of embodiments of an approach for communicating an input signal are described below in the context of communicating a series of video frames. It should, however, be understood that the techniques described are not limited to communication of video. For example, the techniques described below can be applied to communication of audio or sensor data as well. In general, examples of the technique can be applied to a number of examples in which the content being communicated is degradable, for instance, in the sense that it can be communicated with different degrees of quantization. Furthermore, examples of the technique are applicable to wired or wireless communication media, in broadcast, multicast, and point-to-point scenarios.

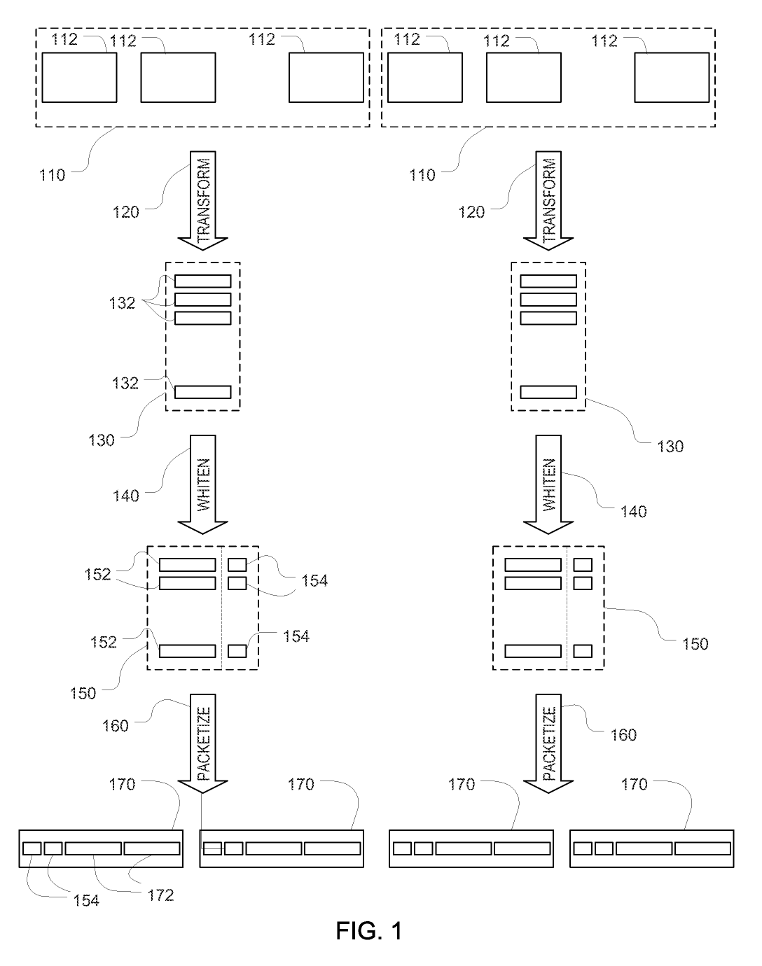

Referring to FIG. 1, an input signal includes a series of video frames 112, which are partitioned into a series of parts 110. In some embodiments as described further below, the frames are partitioned into a series of Groups of Pictures (GoPs). Generally, the process for communicating an encoding of the video frames involves processing each part 110 in turn. For each part 110, a transform 120 is applied to the part to produce component values 130 that represent the part 110. In some examples, the transform involves applying one or more Discrete Cosine Transforms (DCTs) 120 to the pixels of the video frames 112 such that the component values 130 are DCT coefficients. The component values 130 are grouped into equal sized sections, which are referred to in this description as “chunks” 132. In other examples, other transforms, including Wavelet transforms, may be used to determine the component values 130. Note that the frames of data may represent a component of a video signal, for instance, the chrominance, the luminance, one color, etc. In other examples in which the input signal represents a one or multichannel audio or sensor signal, the parts may represent different frequency ranges in a frequency transform representation of the signal.

Note that in general, depending on the transform 120 applied and the way the component values 130 are grouped into chunks 132, the chunks 132 are not necessarily well suited for direct modulation and transmission. In some examples, the degree of variation of component values 130 in each chunk 132 (e.g., average squared deviation about the average) varies from chunk to chunk. Furthermore, direct packaging of chunks 132 into communication packets 170 may result in the reconstructed image being highly affected (e.g., according to a quantitative or perceptual measure of error) by loss of a packet 170.

Continuing to refer to FIG. 1, the chunks 132 of component values 130 are processed through a “whitening” process 140 to yield a set of transmission values 150, which are grouped into sections referred to as “slices” 152. In general, forming the transmission values 150 includes one or both of scaling each of the chunks 132 according to a degree of variation of the values in that chunk 132, and forming the slices 152 such that each slice 152 includes a contribution from multiple or all of the chunks 132 and/or each slice 152 has equal or substantially equal power (e.g., sum of squared values).

One form of scaling of the chunks 132 involves first determining and removing the average value from each chunk 132. As described below, these means are transmitted in a metadata 154 section for each part 110. Then a scale factor is determined for each chunk 132, and the values of the chunks 132 are multiplied by their respective scale factors. The scale factors applied to the chunks 132 are also passed in the metadata 154 for the part 110. In some embodiments, the scale factors for the chunks 132 are determined according to an overall power limit for the part 110, with the scale factors selected to minimize a reconstruction error in the presence of additive degradation of the scaled component values 130 during degradation. As described below, in some embodiments, the scale factors are proportional to the inverse of the fourth root of the average squared value in the chunk 132. In other embodiments, other approaches to selecting scale factors for the chunks 132 may be used according to other error measures, for example, based on different error norms or based on perceptual considerations.

In some embodiments, forming the slices 152 is such that each slice 152 includes a contribution from multiple or all of the chunks 132 is performed by using a set of preselected weighted (e.g., linear) combinations of the chunks 132, such that each slice 152 is formed from a different weighted combination of the chunks 132. In some examples, the weighting coefficients are at either plus or minus one, and the combinations are orthogonal. One choice of such a set of weighted combinations is based on a Hadamard matrix. The combination can be expressed in matrix form by considering the chunks 132 as rows of a matrix that is multiplied by the Hadamard matrix to form a matrix with the slices 152 in its rows. In some examples, this combination step yields a uniform or substantially uniform power in each slice 152.

The set of transmission values 150 then includes the determined slices 152, and metadata 154 corresponding to each of the original chunks 132. The slices 152 and metadata 154 together, with the known linear combinations, are sufficient to reconstruct the chunks 132.

Note that in some embodiments, the number of slices 152 is not necessarily the same as the number of chunks 132. There may be a greater number of slices 152 than chunks 132, which may provide a greater degree of resilience, and the number of slices 152 may be smaller than the number of chunks 132, for example, if the channel does not have sufficient capacity for sending a complete set of slices 152. Furthermore, the number of slices 152 per part may be adapted, for example, based on channel conditions, for instance, available capacity or estimates of noise on the channel.

Continuing to refer to FIG. 1, in a further step, transmission values 150, including the slices 152 and metadata 154 for a each part 110, are assembled into packets 170 for transmission. For example, one or more slices 152 are used to assemble each packet 170.

In some embodiments, each slice 152 is further processed to address variation from value to value in the slice 152. For instance, some transmission systems require relative uniformity of the values, and are not tolerant of large variation in the size of the values. One approach is to transform each slice 152 of transmission values 150 to a corresponding sequence of modulation values 172, for example, by forming linear combinations of the transmission values 150. Again, one approach to forming of linear combinations is to use a Hadamard matrix multiplication. Such a transformation effectively yields statistics for the modulation values 172 as if they were independent draws from an identical statistical distribution (i.e., independent identically distributed, iid, samples). As illustrated in FIG. 1, each packet 170 can include metadata 154 and sections of modulation values 172. Other embodiments do not necessarily include both metadata 154 and modulation values 172 in the same packets 170.

Note that the procedure described to form the modulation values 172 from the component values 130 provides a degree of resilience to packet loss or extreme degradation of particular packets 170. The impact of such a lost or degraded packet 170 is spread at the receiver over multiple or all of the reconstructed component chunks 132.

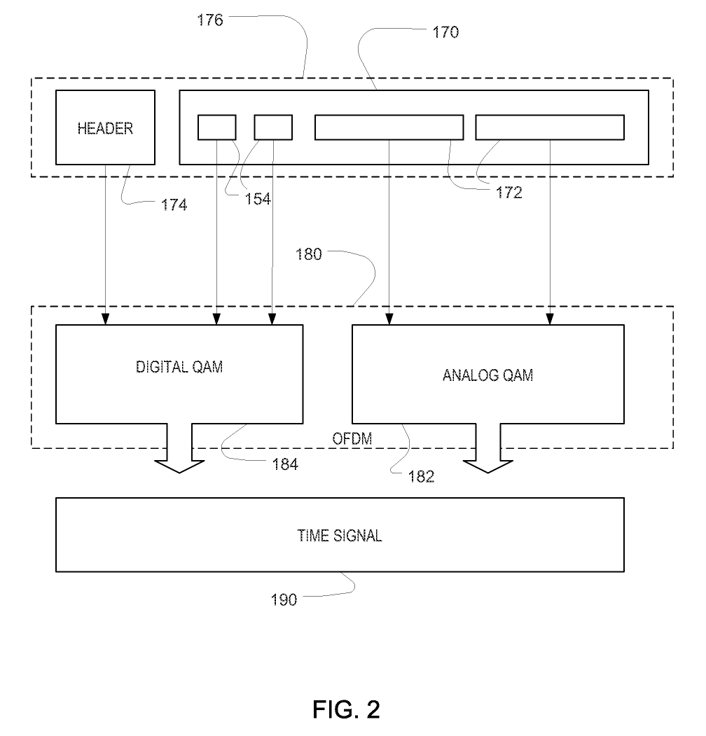

Referring to FIG. 2, in general, each packet 170 may include metadata 154 and other communication system data, such as a packet header 174, as well as the modulation values 172. In some embodiments, an Orthogonal Frequency Division Multiplexing (OFDM) approach is used. The modulation values 172 are encoded using an “analog” Quadrature Amplitude Modulation approach in which pairs of the modulation values 172 are used to directly scale (e.g., multiply) the quadrature components of frequency bins. In some embodiments, the metadata 154 and header data 174 are transmitted in digital form, for example, mapping binary representations of the data to constellation points in a conventional approach. The resulting frequency bins are combined to form a time signal 190 for the packet 170.

In some implementations, packets 170 that include such analog encoding of the modulation values 172 coexist (e.g., in the software stack and on the communication medium) with purely digital packets 170, and the header information 174 in a packet 170 identifies whether the payload is to be decoded as a digitally encoded packet 170 or as an analog encoded packet 170. In some implementations, the vast majority of the communication system is common for both purely digital packets 170 and packets 170 that include analog modulation values 172. Software layers, for example, application, session, or transport layers, provide indications to the lower layers whether a payload is to be transmitted digitally or with analog modulation.

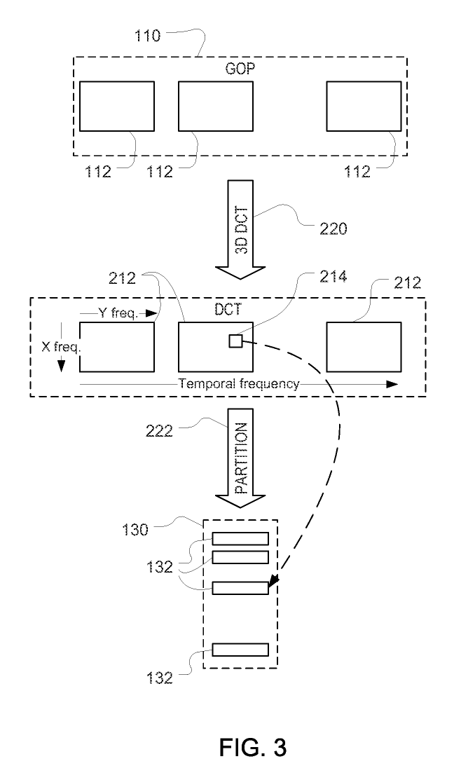

The general approach described above can be applied using various selections of parts, sections, and chunks. For instance, referring to FIG. 3, in one embodiment, each part 110 of the video signal is a GoP, which includes multiple frames 112. The component values 130 are determined using a three-dimensional DCT 220, which produces DCT coefficients that may be arranged into sections 212 according to temporal frequency. Within each section 212, the coefficients correspond to different spatial frequencies. One approach to forming the chunks 132 is to partition the DCT coefficients such that each chunk 132 is formed from a compact region 214 of the coefficients, for instance, corresponding to a range of horizontal and vertical spatial frequencies.

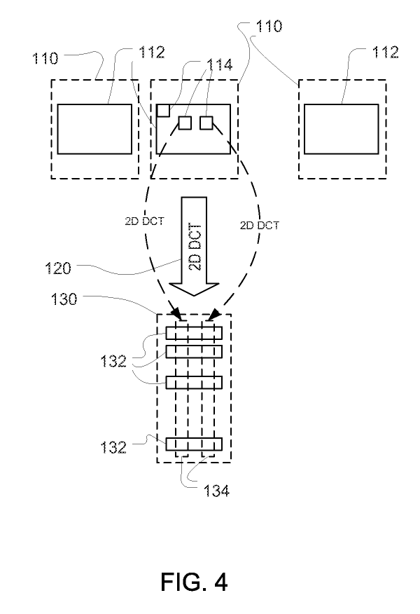

As another instance, referring to FIG. 4, in another embodiment, each part 110 of the video signal is a single frame 112. The frame 112 is divided into blocks 114, for example, each being an eight by eight square block 114 of pixels. Each block 114 is transformed using a two-dimensional DCT 120 to produce 64 coefficients. The coefficients 134 are arranged such that each chunk 132 is made up of the values of the same coefficient for the different blocks of the frame 112. This means that in this example, there are 64 chunks 132, and each chunk 132 has a number of values that is the number of blocks 114 in the frame 112.

### 2 Example Transmitter

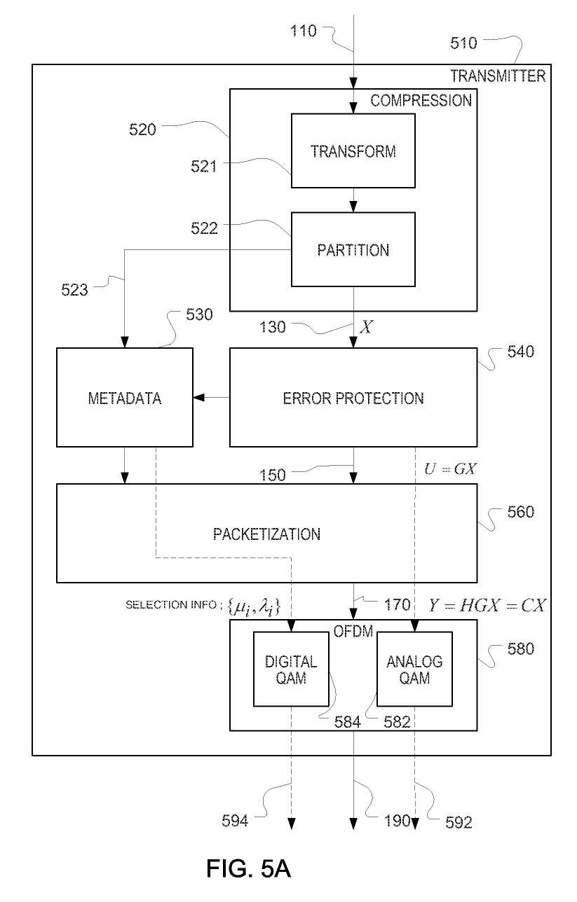

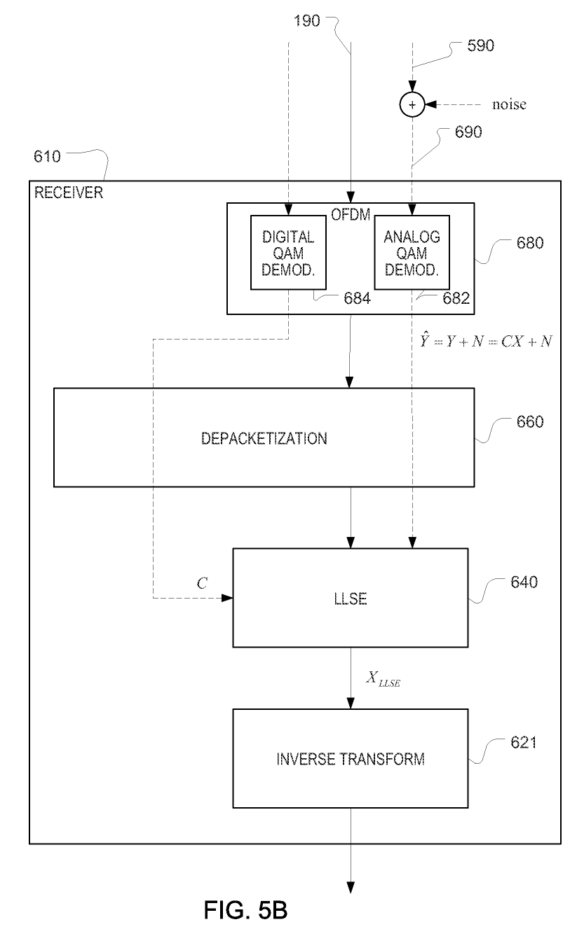

Referring to FIG. 5A, an exemplary embodiment following the general approach outlined above has a transmitter 510, which includes video compression 520, error protection 540, packetization 560 modules, and modulation modules 580 (i.e., the physical (PHY) layer), as presented in detail below. In this example, the transmitter 510 receives a series of video frames arranged into GoPs 110, and the transmitter processes each GoP substantially independently.

### 2.1 Video Compression

In this example, the approach applied by the compression module 520 is to exploit spatial and temporal correlation in a GoP 110 to compact information. A unified approach to intra- and inter-frame compression is used, that is, the same method is used to compress information across space and time. Specifically, the compression module 520 treats the pixel values in a GoP 110 as a 3-dimensional matrix. It takes a 3-dimensional DCT transform 220 of this matrix. The DCT transforms the data to its frequency representation. Since frames are correlated, their frequency representation is highly compact.

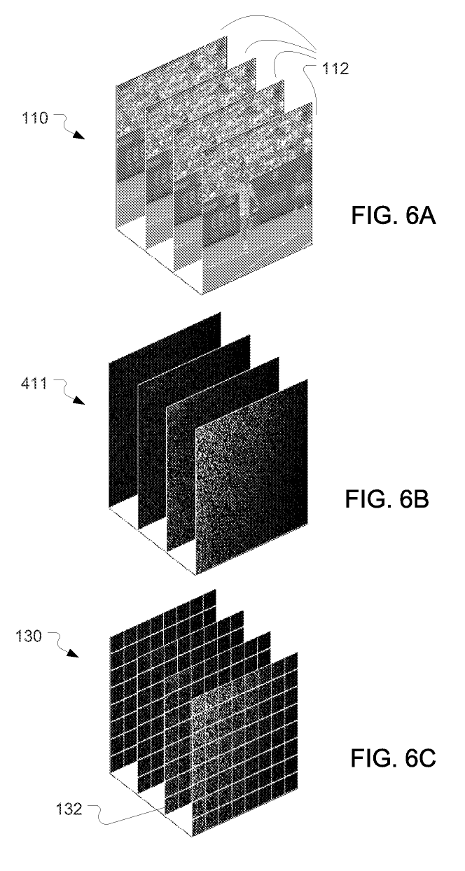

Referring to FIG. 6A, GoP 110 of four frames 112 is shown before passing through a transform module 521, which perform a 3-D DCT on the GoP. FIG. 6B shows the result of the DCT, with the grey levels reflect the magnitude of the DCT component in at corresponding frequences (low spatial frequencies are at the upper left and low temporal frequencies are at the front). FIG. 6C shows partitioning of the DCT coefficients into chunks 132.

FIGS. 6A-C illustrate two properties of 3-D DCT that stem from its energy-compacting capabilities. First, the majority of the DCT components have a zero (black) value (i.e., contain no information). This is because image frames 112 tend to be smooth, causing the high spatial frequencies to be zero. Further, most of the structure in a video stays constant across multiple frames, and hence most of the higher temporal frequencies tend to be zero. This means that one can discard all of the zero-valued DCT components without affecting the quality of the video.

A second property is that non-zero DCT components are clustered into compact frequency regions (i.e., regions in which the horizontal and vertical spacial frequencies are approximately equal). This is because spatially nearby DCT components represent nearby spatial frequencies, and natural images exhibit smooth variation across spatial frequencies. This means that one can express the locations of the retained DCT components with little information by referring to clusters of DCT components rather than individual components.

In some examples, these two properties are exploited to efficiently compress the data by transmitting only the non-zero or sufficiently large DCT components. This compression is very efficient and has no (or limited) impact on the energy in a frame 112. However, it can require the transmitter to send metadata to the receiver to inform it of the locations of the discarded DCT components, which may be a large amount of data.

In some examples, to reduce the amount of metadata 154, nearby spatial DCT components are grouped by a partition module 522 into chunks 132, as shown in FIG. 6C. In some examples, the default chunk 132 is 44×30×1 pixels, (44×30 is chosen based on the SIF video format where each frame is 352×240 pixels). Note that this example transmitter does not group temporal DCT components because typically only a few structures in a frame 112 move with time, and hence most temporal components are zero, as is clear from FIG. 6C. The transmitter then makes one decision for all DCT components in a chunk 132, either retaining or discarding them. The clustering property of DCT components allows the transmitter to make one decision per chunk 132 without compromising the compression it can achieve. The partition module 522 passes information 523 identifying the selected chunks to a metadata module 530, for passing to over the communication channel to the receiver. As in other examples, the transmitter informs the receiver of the locations of the non-zero chunks 132, but this overhead is significantly smaller since each chunk 132 represents 1320 DCT components. The transmitter sends this location information as a bitmap. Again, due to clustering, the bitmap has long runs of consecutive retained (similarly, consecutive discarded) chunks 132, and hence the selection information 523 is efficiently compressed using run-length encoding.

The output of the compression module 520 is represented in FIG. 5A as chunks 130, labelled X, which is a matrix encoding of the selected chunks with one chunk per row of the matrix.

The previous discussion assumes that the source has enough bandwidth to transmit all the non-zero chunks 132 over the wireless medium. In some examples, the source is bandwidth constrained. In some such examples, the partition module at the transmitter judiciously selects non-zero chunks 132 so that the transmitted stream can fit in the available bandwidth, and still be reconstructed with the highest quality. The transmitter selects the transmitted chunks 132 so as to minimize the reconstruction error at the receiver:

$$err = {\sum }_{i} ( {\sum }_{j} {( {x}_{i} [ j ] - {\hat{x}}_{i} [ j ] )}^{2} ) ,$$

where xᵢ[j] is the original value for the j^{th} DCT component in the i^{th} chunk 132, and \hat{x}ᵢ[j] is the corresponding estimate at the receiver.

As described more fully below, when a chunk 132 is discarded at the transmitter, the receiver estimates all DCT components in that chunk 132 as zero. Hence, the error from discarding a chunk 132 is merely the sum of the squares of the DCT components of that chunk 132. Thus to minimize the error, the transmitter sorts the chunks 132 in decreasing order of their energy (the sum of the squares of the DCT components), and picks as many chunks 132 as possible to fill the bandwidth.

Note that bandwidth is a property of the source, (e.g., a 802.11 channel has a bandwidth of 20 MHz) independent of receiver, whereas SNR is a property of the receiver and its channel. As a result, discarding non-zero chunks 132 to fit the source bandwidth does not prevent each receiver from getting a video quality commensurate with its SNR.

Two points are worth noting about the compression approaches used in one or more examples by the compression module 520 as described above. First, the transmitter can capture correlations across frames while avoiding motion compensation and differential encoding. It does this because it performs a 3-D DCT, as compared to the 2-D DCT performed by MPEG. The ability of the 3-D DCT 220 to compact energy across time is apparent from FIG. 6C where the values of the temporal DCT components die quickly (i.e., high temporal frequency planes are almost all black). Second, a main computation performed by in compression is the 3-D DCT, which is O(K log(K)), where K is the number of pixels in a GoP 110. A variety of efficient DCT implementations can be used, both in hardware and software.

### 2.2 Error Protection

In general, traditional error protection codes transform the real-valued video data to bit sequences. This process can destroy the numerical properties of the original video data and can make it difficult to achieve a goal of having the distance between transmitted digital samples scale with the difference between the pixel values. In the present approach this goal is matched by scaling the magnitude of the DCT components in a frame. Scaling the magnitude of a transmitted signal provides resilience to channel noise. To see how, consider a channel that introduces an additive noise in the range ±0.1. If a value of 2.5 is transmitted directly over this channel, (e.g., as the I or Q of a digital sample), it results in a received value in the range [2.4-2.6]. However, if the transmitter scales the value by 10×, the received signal varies between 24.9 and 25.1, and hence when scaled down to the original range, the received value is in the range [2.51-2.49], and its best approximation given one decimal point is 2.5, which is the correct value. However, when the hardware has a fixed power budget, scaling up and therefore expending more power on some signal samples translates to expending less power on other samples. The approach described below applied the optimal scaling factors that balance this tension.

As described above, and referring to FIGS. 5A-B, examples of transmitters operate over chunks 132. The error protection module 540 finds scaling factors for the DCT coefficients that appropriately protects the information in those coefficients using a scaling approach. Instead of finding a different scaling factor for each DCT component, a single optimal scaling factor is determined for all the DCT components in each chunk 132. To do so, we model the values xᵢ[j] within each chunk 132 i as random variables from some distribution Dᵢ. The error protection module 540 removes the mean μᵢ from each chunk 132 to get zero-mean distributions and sends the means to the metadata module 530. Given the mean, the amount of information in each chunk 132 is captured by its variance. We compute the variance of each chunk 132, λᵢ. Given these variances, we define an optimization problem that finds the per-chunk scaling factors such that GoP 110 reconstruction error is minimized.

The selection of scaling factors for each of the chunks can be understood based on the following. Let xᵢ[j], j=1K N, be random variables drawn from a distribution Dᵢ with zero mean, and variance λᵢ. Given a number of such distributions, i=1K C, a total transmission power P, and an additive white Gaussian noise channel, the linear encoder that minimizes the mean square reconstruction error is:

$${u}_{i} [ j ] = {g}_{i} {x}_{i} [ j ] , where {g}_{i} = {λ}_{i}^{- 1 / 4} ( \sqrt{\frac{P}{{\sum }_{i} \sqrt{{λ}_{i}}}} ) .$$

Note that there is only one scaling factor gᵢ for every distribution Dᵢ, that is, one scaling factor per chunk 132. The output of the encoder is a series of coded values, uᵢ[j], as defined above. Further, the encoder is linear since DCT is linear and our error protection code performs linear scaling. The error protection module 540 passing the scaling factors, which can be represented as a diagonal matrix G to the metadata module, and passes the scaled chunks, which can be represented as a matrix U=GX with each row having one scaled chunk.

### 2.3 Packetization

Next, the packetization module 560 of the transmitter 510 assigns the coded DCT values to packets 170 that are then passed to the physical (PHY) layer, which in this example uses an OFDM module 580. The packetizion module 560 ensures that all packets 170 contribute equally to the quality of the reconstructed video. The packetizion module 560 does this so that the loss of some packets 170 does not hamper decoding, and the more packets 170 the receiver captures, the better the quality of the decoded GoP 110.

In some examples, individual chunks 132 are assigned to packets 170. A problem with such an approach, however, is that chunks 132 do not, in general, have equal characteristics. Chunks 132 differ widely in their energy. Chunks 132 with higher energy are more important for video reconstruction. Thus, assigning chunks 132 directly to packets 170 can cause some packets 170 to be more important than others, and their loss more detrimental to the reconstruction of the video.

In other examples, the chunks 132 are transformed into equal-energy slices. Each slice is a linear combination of all chunks 132. The transmitter produces these linear combinations by multiplying the chunks 132 with the spreading matrix, which in this example is a Hadamard matrix. The Hadamard matrix is an orthogonal transform composed entirely of +1 s and −1 s. Multiplying by this matrix creates a new representation where the energy of each chunk 132 is smeared across all slices 152. The transformation of the scaled chunks U to slices can be represented in matrix form as a multiplication Y=HU=HGX, where H is the Hadamard matrix. Because the structure of the Haramard matrix is known by both the transmitter and the receiver, its structure does not have to be transmitted with the data.

The transmitter then assigns slices to packets 170. Note that, a slice has the same size as a chunk 132, and depending on the chosen chunk size, a slice might fit within a packet 170, or require multiple packets 170. Regardless, the resulting packets 170 will have equal energy, and hence offer better packet loss protection. These packets 170 are delivered directly to the OFDM module 580, which forms the Physical Layer (PHY), via a raw socket, which interprets their data directly as the digital signal samples to be sent on the medium via an analog QAM module 582.

In addition to the video data Y, the transmitter sends a small amount of metadata to assist the receiver in inverting the received signal. Specifically, the transmitter sends information representing the mean, μᵢ, and the variance, λᵢ, of each chunk 132, and a bitmap that indicates the discarded chunks 132. The receiver can compute the scaling factors, gᵢ, from this information. The Hadamard and DCT matrices are known to the receiver and do not need to be transmitted. The bitmap of chunks 132 is compressed using run length encoding, and all metadata is further compressed using Huffman coding, coded for error protection using a Reed-Solomon code, and transmitted at the lowest 802.11 rate for robustness. Though the metadata has to be delivered to all receivers, its overhead is low (0.007 bits/pixel in some implementations).

### 2.4 A Matrix View of the Transmitter

As introduced above, we can compactly represent the encoding process of a GoP 110 as matrix operations. Specifically, we can represent the DCT components in a GoP 110 as a matrix X where each row is a selected chunk 132. We can also represent the final output of the transmitter as a matrix Y where each row is a slice 152. The encoding process can then be represented as

Y=HGX=CX

where G is a diagonal matrix with the scaling factors, gᵢ, as the entries along the diagonal, H is the Hadamard matrix, and C=HG is simply the encoding matrix.

### 3 Example Video Receiver

At the receiver 620, each received packet is demodulated by the OFDM demodulator 680. The parts of the packet that were modulated by the analog QAM modulator 582 at the transmitter are demodulated by an analog QAM demodulator 682, which the coded DCT values in that packet. The end result is that for each value yᵢ[j] that we sent, we receive a value ŷᵢ[j]=yᵢ[j]+nᵢ[j], where nᵢ[j] is random noise from the channel. It is common to assume the noise is additive, white and Gaussian.

The goal of the receiver is to decode the received GoP 110 in a manner that minimizes the reconstruction errors. We can write the received GoP 110 values as

Ŷ=CX+N,

where Ŷ is the matrix of received values, C is the encoding matrix X is the matrix of DCT components, and N is a matrix where each entry is white Gaussian channel noise.

Without loss of generality, we can assume that the slice size is small enough that a slice 152 fits within a packet 170, and hence each row in Ŷ is contained in a single packet. If the slice size is larger than the packet size, then each slice consists of more than one packet 170, say, K packets 170. The receiver simply needs to repeat its algorithm K times. In the i^{th} iteration (i=1K K), the receiver constructs a new Ŷ where the rows consist of the i^{th} packet 170 from each slice 152. For the rest of our exposition, therefore, we will assume that each packet 170 contains a full slice 152.

A depacketization module 660 of the receiver accepts the demodulated values, Ŷ, and constructs the encoding matrix C=HG from the metadata that is passed via the digital QAM demodulator 684. The demodulated values, the encoding matrix, as well as the selection information that identifies the chunks selected at the transmitter are passed to the LLSE module 640.

The LLSE module is configured to compute its best estimate of the original DCT components, X, from the information it receives. The linear solution to this problem is widely known as the Linear Least Square Estimator (LLSE). The LLSE provides a high-quality estimate of the DCT components by leveraging knowledge of the statistics of the DCT components, as well as the statistics of the channel noise as follows:

X_{LLSE}=ΛₓC^{T}(CΛₓC^{T}+Σ)⁻¹Ŷ,

where:
X_{LLSE} refers to the LLSE estimate of the DCT components.
C^{T} is the transpose of the encoder matrix C.
Σ is a diagonal matrix where the i^{th} diagonal element is set to the channel noise power experienced by the packet 170 carrying the i^{th} row of Ŷ. The physical layer at the receiver typically has an estimate of the noise power in each packet, and can expose it to the higher layer).
Λₓ is a diagonal matrix whose diagonal elements are the variances, λᵢ, of the individual chunks 132. Note that the λᵢ's are transmitted as metadata by the transmitter.

Consider how the LLSE estimator changes with SNR. At high SNR (i.e., small noise, the entries in Σ approach 0), the LLSE can be approximated:

X_{LLSE}≈C⁻¹Y

Thus, at high SNR, the LLSE estimator simply inverts the encoder computation. This is because at high SNR we can trust the measurements and do not need to leverage the statistics, Λ, of the DCT components. In contrast, at low SNR, when the noise power is high, one cannot fully trust the measurements and hence it is better to re-adjust the estimate according to the statistics of the DCT components in a chunk.

Once the LLSE module 640 has obtained the DCT components in a GoP 110, it passes these to an inverse transform module 621, which reconstructs the original frames 112 by taking the inverse of the 3-D DCT.

In contrast to conventional 802.11, where a packet is lost if it has any bit errors, the receiver accepts all packets. Thus, packet loss occurs only when the hardware fails to detect the presence of a packet, e.g., in a hidden terminal scenario.

When a packet is lost, the receiver can match it to a slice 152 using the sequence numbers of received packets 170. Hence the loss of a packet 170 corresponds to the absence of a row in Y. Define Y_{*i} as Y after removing the i^{th} row, and similarly C_{*i} and N_{*i} as the encoder matrix and the noise vector after removing the i^{th} row. Effectively:

Ŷ_{*i}=C_{*i}X+N_{*i}.

The LLSE decoder becomes:

X_{LLSE}=ΛₓC_{*i}^{T}(C_{*i}ΛₓC_{*i}^{T}+Σ_{(*i,*i)})⁻¹Ŷ_{*i}.

Note that we removed a row and a column from Σ. This equation gives the best approximation of Y when a single packet is lost. The same approach extends to any number of lost packets. The receiver's approximation degrades gradually as receivers lose more packets 170 and, unlike MPEG, there are no special packets whose loss prevents decoding.

### 4 Example PHY Layer

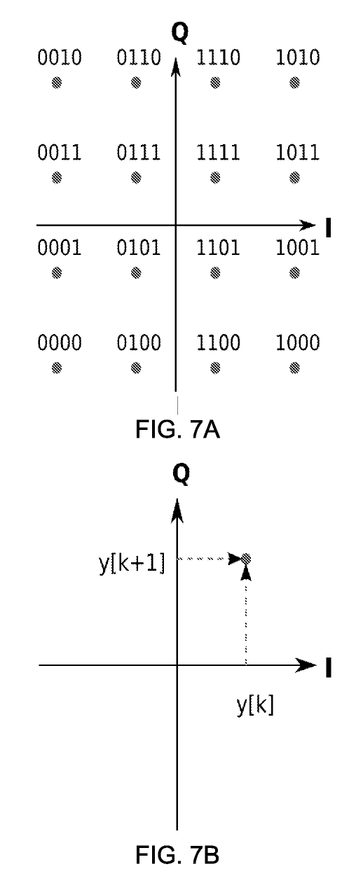

Traditionally, the PHY layer takes a stream of bits and codes them for error protection. It then modulates the bits to produce real-value digital samples that are transmitted on the channel. For example, referring to FIG. 7A, 16-QAM modulation takes sequences of 4 bits and maps each such sequence to a complex number. The real and imaginary parts of these complex numbers produce the real-valued I and Q components of the transmitted signal. The Digital QAM module 584 describe above with reference to FIG. 5A, for example, operates in this manner.

Referring to FIG. 7B, in contrast to existing wireless design, the Analog QAM module 582 outputs real values that are already coded for error protection. Thus, we can directly map pairs of coded values to the I and Q digital signal components, as illustrated in FIG. 7B

To integrate this design into the existing 802.11 PHY layer, the fact that OFDM separates channel estimation and tracking from data transmission is leveraged. As a result, how the data is coded and modulated is changed without affecting the OFDM behavior. Specifically, OFDM divides the 802.11 spectrum into many independent subcarriers, some of which are called pilots and used for channel tracking, and the others are left for data transmission. The transmitter does not modify the pilots or the 802.11 header symbols, and hence does not affect traditional OFDM functions of synchronization, carrier frequency offset (CFO) estimation, channel estimation, and phase tracking The transmitter simply transmits in each of the OFDM data bins. Such a design can be integrated into the existing 802.11 PHY simply by adding an option to allow the data to bypass FEC and QAM, and use raw OFDM. Streaming media applications can choose the raw OFDM option, while file transfer applications continue to use standard OFDM.

### 5 Evaluation Environment

An example embodiment of the approaches described above has been implemented and evaluated in comparison with single-layer MPEG-4 and two-layer MRC. The example embodiment of the present is referred to in some instances below as “SoftCast” without intending to associate the described system with others systems described elsewhere with that identifier.

For reference, the H.264/MPEG-4 AVC codec was used as a baseline. MPEG-4 streams were generated using the open source FFmpeg software and the x264 codec library. FFmpeg and x264 was used to implement a multiresolution coding (MRC) scheme that encodes the video into a base layer and an enhancement layer, based on the SNR scalable profile method which first encodes the video at a coarse quality generating the base layer, and encodes the residual values as the enhancement layer. All the schemes: MPEG-4, MRC, and SoftCast use a GoP of 16 frames.

The testing setup is based on trace-driven experiments. The approach ensures that all compared schemes are subjected to the same wireless channel, and hence performance differences are only due to inherent properties of the schemes. Specifically, digital signal samples are first collected for transmissions between pairs of locations using the WARP radio platform. The measurements span SNRs from 4 to 25 dB, which is the operational range of 802.11.

In each experiment, a known bit pattern is transmitted and the received soft values (i.e. the I and Q values of the received signal after the hardware has compensated for channel effects, and frequency offsets) are collected. The noise patterns induced by the channel can then be extracted by subtracting the transmitted soft values from the received soft values.

These empirical noise patterns are applied to the transmitted digital signal for each of the schemes to evaluate the effect of the wireless channel on them. The transmitted digital signals for the baselines (MPEG-4 and MRC) are generated by feeding the output of their codecs to the reference 802.11 PHY (modulation, coding, and OFDM) implementation in MATLAB's communication toolbox. The transmitted digital signal for SoftCast is generated by feeding the output of our encoder to the Matlab reference OFDM implementation.

The schemes are compared using the Peak Signal-to-Noise Ratio (PSNR). PSNR is a standard measure of video quality and is defined as a function of the mean squared error (MSE) between all pixels of the decoded video and the original version as follows:

$$PSNR = 10 {log}_{10} \frac{{2}^{L} - 1}{MSE} [ dB ] ,$$

where L is the number of bits used to encode pixel luminance, typically 8 bits. A PSNR below 20 dB refers to bad video quality, and differences of 1 dB or higher are visible.

Standard reference videos in the SIF format (352×240 pixels, 30 fps) from the Xiph collection are used. Since codec performance varies from one video to another, one monochrome 480-frame test video is created by splicing 1 second from each of 16 popular reference videos: akiyo, bus, coastguard, crew, flower, football, foreman, harbour, husky, ice, news, soccer, stefan, tempete, tennis, waterfall.

### 6 Evaluation Results

The performance of the tested “SoftCast” implementation in various scenarios is reported and the contributions of its components are evaluated. Video performance is represented using graphs of the video PSNR.

### 6.1 Benchmark Results

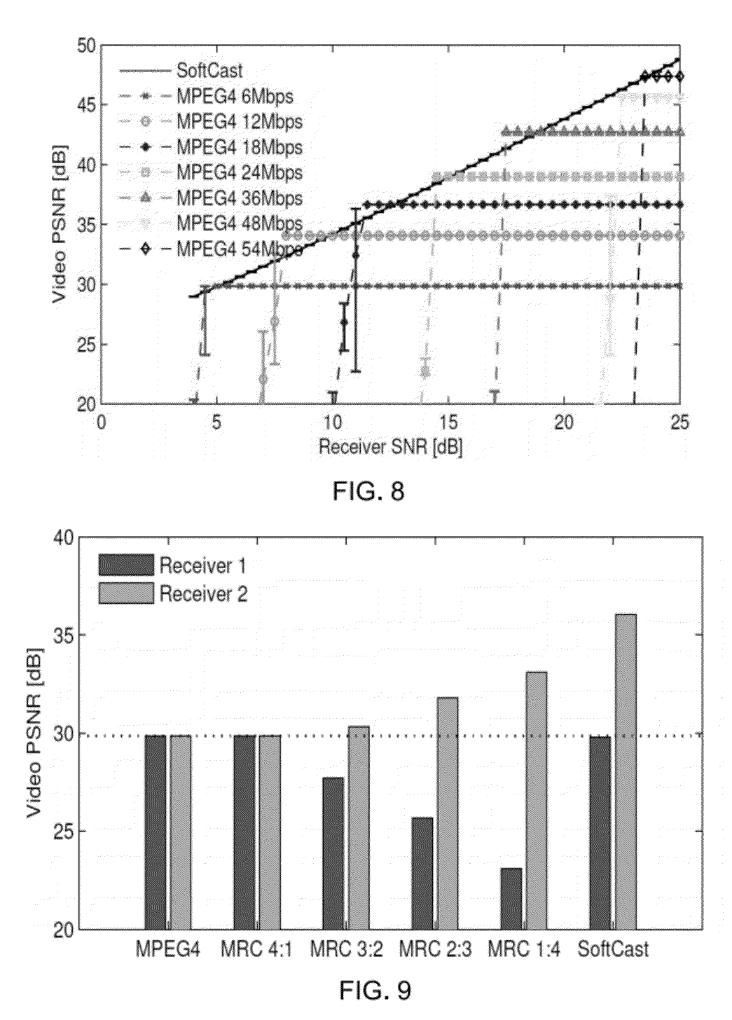

In the baseline experiment, the source sends a video signal to a single static receiver with a stable channel SNR. The channel SNR is varied by varying the location of the receiver, and using channel traces from these different locations. For each channel SNR, both the present SoftCast approach and MPEG-4 are evaluated on the same trace. MPEG-4 is allowed to try all choices of 802.11 bitrates, and for each bitrate, use the video code rate that matches the channel bitrate. Each run is repeated 100 times and FIG. 8 reports the median video quality metric (PSNR) along with the minimum and maximum.

Referring to FIG. 8, the cliff effect characteristic of current wireless video approaches is confirmed. Specifically, for each 802.11 bit rate, there exists a critical SNR below which MPEG-4 degrades sharply due to a high bit error rate (BER); conversely, above the critical SNR, the video is delivered virtually error-free but the video quality (PSNR) is limited by the compression loss introduced at the MPEG-4 encoder. In contrast, the video quality (PSNR) 800 of the present approach scales smoothly with the channel SNR. Further, this PSNR matches that of MPEG-4 with the optimal bitrate (and video codec rate) at each channel SNR, even though the present approach does not require any bitrate or code rate adaptation.

### 6.2 Multicast

Next, the performance of video multicast under MPEG-4, MRC and SoftCast is examined. First, a simple multicast experiment with two receivers whose SNRs are 5 and 12 dB is run, and their optimal bit rates are 6 Mb/s and 18 Mb/s, respectively. Experimentation for multicasting the video with MPEG-4, MRC, and the present approach is performed. With MPEG-4, the source is configured to use a transmit rate of 6 Mb/s as that is the highest bitrate supported by both receivers. With MRC, the source is configured to transmit the base layer at 6 Mb/s (so that it can be received by both receivers) and the enhancement layer at 18 Mb/s (so that it can be received at the better receiver). Since the two layers share the wireless medium, the source has to decide how to divide medium access between the layers. Various such allocations are considered. With the present approach, the source can transmit a single stream to both receivers, and neither needs to pick a bitrate nor divide medium access between layers. FIG. 9 shows the PSNR of the two receivers given these options.

Referring to FIG. 9, with MPEG-4, the video PSNR for both receivers is limited by the receiver with the worse channel. In contrast, two-layer MRC can provide different performance for the two receivers. However, MRC has to make a trade-off: The higher the fraction of medium time devoted to the enhancement layer, the better the performance of the stronger receiver, but the worse the performance of the weaker receiver. This is because the two layers share the wireless medium, and hence allocating resources to the enhancement layer takes them away from the base layer, and consequently reduces the overall performance of the weak receiver. SoftCast does not divide the resources between layers or receivers; it can therefore provide the stronger receiver with a higher PSNR without hampering the performance of the weaker receiver.

In an experiment focussed at diverse groups, 100 different multicast groups are created by picking a random sender and different subsets of receivers in the testbed. Each multicast group is parameterized by the range of receiver SNRs. The average SNR of all multicast groups is held constant at 15 (±1) dB, which is the average SNR of the testbed, and the range of the SNRs in the group is varied from 0-10 dB. Each multicast group has up to 20 receivers, with multicast groups with zero standard deviation having only one receiver. For each group, each of the three compared schemes is run. MPEG-4 and MRC are allowed to optimize their parameter settings offline after they are given access to the exact receiver SNRs in the multicast group instance; specifically, MPEG-4 is allowed to try all possible bitrates (and the corresponding optimal video code rate) that maximize the average PSNR across all receivers in the group. Similarly to MPEG-4, MRC has to pick an 802.11 bit-rate (hence a video codec rate) for each layer. Additionally, it has to pick how to divide the medium access between its two layers. For each group, MRC is allowed to try all combinations of parameters in Table 1 and pick the combination that maximizes the average PSNR for the receivers in that group.

Referring to FIG. 10, the average PSNR in a multicast group as a function of the standard deviation in the receivers' SNRs is plotted. It shows that SoftCast delivers a PSNR gain of upto 7 dB over MPEG-4, and upto 8 dB over MRC for diverse multicast groups. Further, SoftCast continues to deliver the same average performance for groups with increasing SNR standard deviation, in contrast to both MPEG-4 and MRC, whose performance degrades with increasing diversity in the multicast group. As with the two-receiver group, there is no advantage for using MRC instead of single-layer MPEG-4. This is because MRC splits wireless bandwidth between a base and an enhancement layer, and hence compromises the base quality received by the poorest receivers, without providing commensurate quality improvement to the good receivers.

### 6.3 Mobility

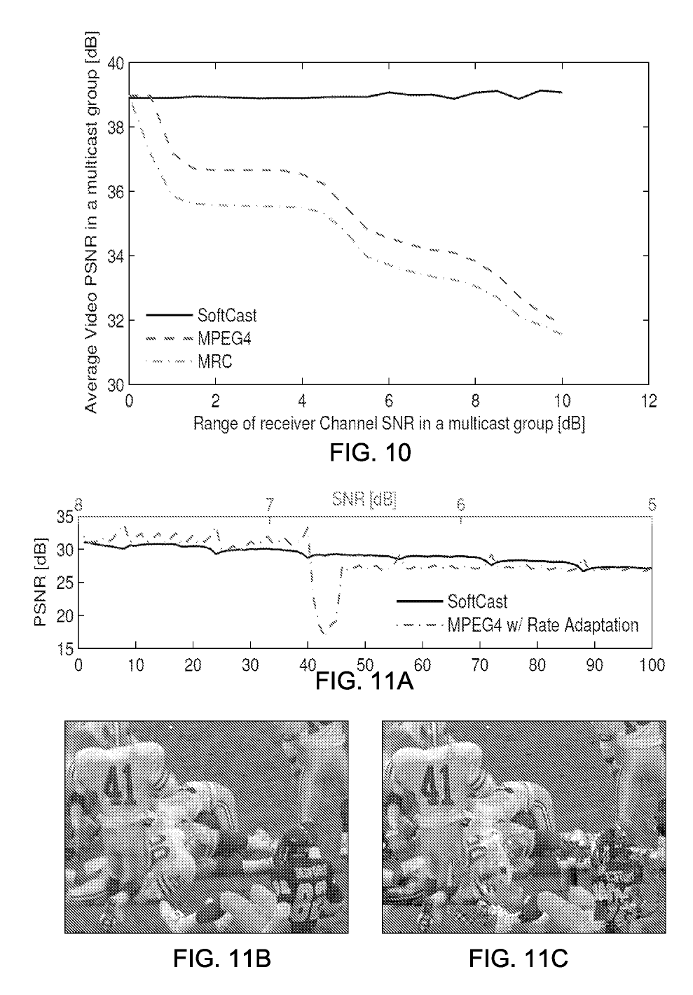

In an experiment focussed on mobility, a receiver moves away from its source causing a relatively small change of 3 dB in channel SNR (from 8 dB to 5 dB). Two schemes are compared. In the first, the source transmits its video over SoftCast. In the second, the source transmits its video over MPEG-4, with bitrate adaptation and video code rate adaptation. An SNR-based bitrate adaptation algorithm is used, where, for each channel SNR, the algorithm is trained offline to pick the best bitrate supported by that SNR. MPEG-4 is allowed the flexibility of switching the video code rate at every GoP boundary in order to match the bitrate used by rate adaptation. FIG. 11A plots the instantaneous per-frame PSNR for both SoftCast and MPEG-4 as a function of the channel SNR at that instant. FIG. 11A compares the video quality of MPEG-4 and SoftCast under mobility. MPEG-4 is allowed to adapt the 802.11 bitrate and the video codec rate. The x-axis refers to receiver SNR (top) and frame id (bottom), and the y-axis refers to the per-frame PSNR as the receiver moves away from the video source. The Figure shows that even when the MPEG-4 system is allowed bitrate adaptation and video codec adaptation, the receiver still sees significant glitches in video quality. In contrast, SoftCast is robust to variations in SNRs, and hence it naturally works with mobility without bitrate adaption or video code rate adaptation. FIGS. 11B and 11C show frame 45 in SoftCast and MPEG-4, respectively, to illustrate the video quality.

Referring to FIG. 11A, with mobility, the conventional wireless design based on MPEG-4 experiences significant glitches in video quality. These glitches happen when a drop in the transmission bitrate causes packet losses or corruption, which significantly affect MPEG-4 because of its inter-packet dependencies induced by differential encoding and motion compensation. In comparison, SoftCast's performance is stable even in the presence of mobility.

### 6.4 Resilience to Packet Loss

The resilience of both MPEG-4 and SoftCast to packet loss is evaluated. The effectiveness of the schemes introduced in SoftCast's encoder and decoder to counter packet loss is also evaluated. Specifically, the SoftCast encoder ensures that the energy in a video is spread equally across all packets using the Hadamard matrix.

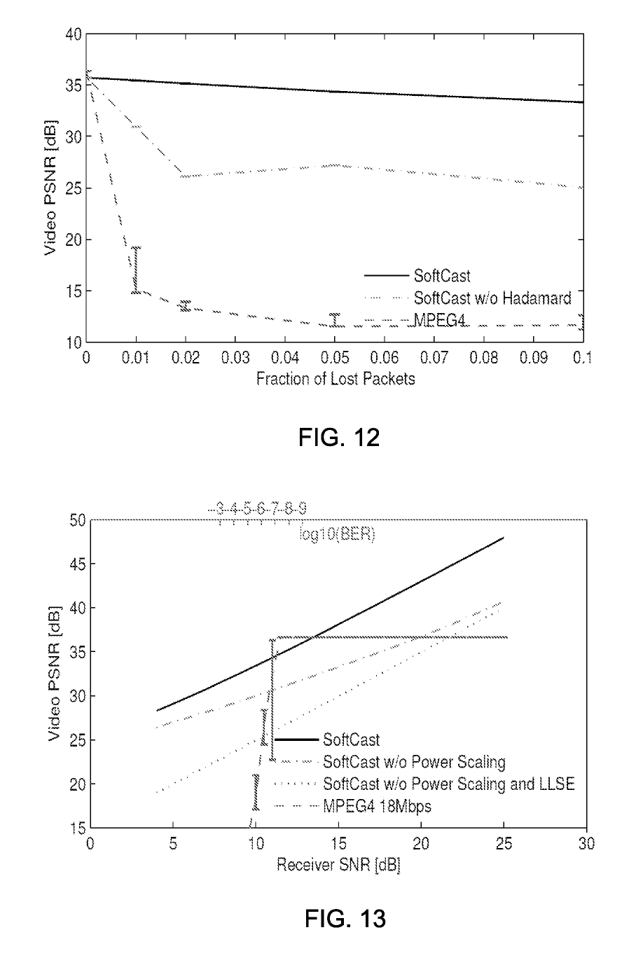

In this experiment, a trace corresponding to a sender-receiver pair is chosen, and packet losses are uniformly introduced at random with increasing probability. This experiment is repeated for 10 different sender-receiver pairs, with an average SNR of 15 dB. The three schemes: MPEG-4, full-fledged SoftCast, and SoftCast are compared after disabling Hadamard multiplication. Referring to FIG. 12, the video PSNR at the receiver across all these traces as a function of packet loss probability is reported.

Referring to FIG. 12, the quality of an MPEG-4 video drops sharply even when the packet loss rate is less than 1%. This is because MPEG-4 introduces dependencies between packets due to Huffman encoding, differential encoding and motion compensation, as a result of which the loss of a single packet within a GoP can render the entire GoP undecodable. In contrast, SoftCast's performance degrades only gradually as packet loss increases, and is only mildly affected even at a loss rate as high as 10%. The figure also shows that Hadamard multiplication significantly improves SoftCast's resilience to packet loss. Interestingly, SoftCast is more resilient than MPEG-4 even in the absence of Hadamard multiplication.

SoftCast's resilience to packet loss comes from multiple factors. A first factor is the use of a 3-D DCT ensures that all SoftCast packets include information about all pixels in a GoP, hence the loss of a single packet does not create patches in a frame, but rather distributes errors smoothly across the entire GoP.

Further, SoftCast packets are not coded relative to each other as is the case for differential encoding or motion compensation, and hence the loss of one packet does not prevent the decoding of other received packets.

All SoftCast packets have equal energy as a result of Hadamard multiplication, and hence the decoding quality degrades gracefully as packet losses increase. The LLSE decoder, in particular, leverages this property to decode the GoP even in the presence of packet loss, as explained in.

### 6.5 Error Protection

The intrinsic robustness of SoftCast and MPEG-4 to channel errors is examined. The effectiveness of the schemes used by SoftCast's encoder and decoder to achieve this resilience is also examined. Specifically, the SoftCast encoder performs linear scaling of DCT components to provide error protection, whereas the SoftCast decoder uses the LLSE to decode GoPs in the presence of noise.

In this experiment, a trace corresponding to a single sender-receiver pair is chosen. The channel SNR is varied by using different receiver locations in the testbed. This configuration is used evaluate both SoftCast and MPEG-4 across a variety of channel SNRs. In order to examine MPEG-4's robustness to bit error rates, bitrate adaptation is disabled, and MPEG-4 is run over a fixed 802.11 bitrate of 18 Mb/s. Of course, this bitrate is too high for some of the SNRs in the range, but such a situation can occur in practice, for example, with multicast if MPEG-4 picks a bitrate that cannot be supported by the SNR of the worst receiver in the group, or with mobility, if the receiver's SNR drops suddenly and cannot support the bitrate currently used by the source. All received packets are passed, including those with errors, to the MPEG-4 decoder. FIG. 13 plots the PSNR of the decoded video as a function of channel errors. Channel errors manifest themselves as bit errors for MPEG-4, and noisy DCT values for SoftCast. Four schemes are compared: MPEG-4, SoftCast, SoftCast with linear scaling disabled, and SoftCast with both linear scaling and LLSE disabled.

Referring to FIG. 13, MPEG-4 displays a cliff effect, i.e. its PSNR drops drastically when the bit error rate exceeds 10⁻⁶. In contrast, a SoftCast video operating over the same channel is significantly more resilient to channel errors. The figure also shows that SoftCast's approach to error protection based on linear scaling and LLSE decoding contribute significantly to its resilience. Specifically, linear scaling is important at high SNRs since it amplifies fine image details and protects them from being lost to noise. In contrast, the LLSE decoder is important at low SNRs when receiver measurements are noisy and cannot be trusted, because it allows the decoder to leverage its knowledge of the statistics of the DCT components.

### 6.6 Compression

Finally, the effectiveness of SoftCast's compression is evaluated. SoftCast compresses the video stream by taking a 3-D DCT and selecting low energy chunks to discard, so that it achieves the target compression.

In this experiment, both SoftCast and MPEG-4 encode the same video at various compression levels. For example, a compression level of 0.3 corresponds to reducing the video to 30% of its original size. The compressed video is decoded, and plot the PSNR of the decoded video as a function of the compression level.

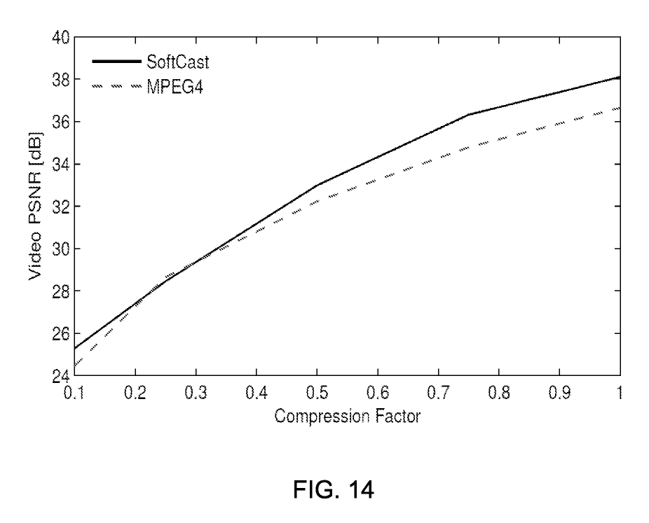

Referring to FIG. 14, the efficiency of SoftCast's compression is comparable to MPEG-4. Specifically, the PSNR of SoftCast is within 0.5 dB of the PSNR of MPEG-4 for all compression levels. By avoiding compression techniques that create dependencies across packets such as Huffman coding, differential encoding, and motion compensation, SoftCast pays a small cost of 0.5 dB in terms of compression efficiency, but in return, obtains significant improvements in resilience to packet loss and channel errors.

### 7 Implementations and Alternatives

Examples of the techniques described above may be applied to communication over wired or wireless media. Examples of communication over wired media include communication over cable television or DSL circuits. In the case of communication over cable networks, a single signal may be transmitted to multiple subscribers, each of which may experience different degrees of degradation of the signal.

Embodiments of the approaches described above may be implemented in hardware, in software, or in a combination of hardware or software. The software may include instructions embodied on a tangible machine readable medium, such as a solid state memory, or embodied in a transmission medium in a form readable by a machine. The instructions may include instructions for causing a physical or virtual processor to perform steps of the approaches described above. In some software implementations, the PHY layer provides an interface that accepts data for transmission from software applications such that some accepted data is modulated in analog form and some is modulated in digital form. For instance, the interface accepts an indication of which data should be modulated in each form. Hardware implementations may include, for example, general purpose or reconfigurable circuitry, or custom (e.g., application specific) integrated circuits.

It is to be understood that the foregoing description is intended to illustrate and not to limit the scope of the invention, which is defined by the scope of the appended claims. Other embodiments are within the scope of the following claims.

What is claimed is:

1. A method for communicating an input signal comprising:
for each of a series of parts of the input signal,
forming a plurality of component values for components for the part of the signal, the plurality of component values being partitioned into a set of sections of component values, and
forming a plurality transmission values from the plurality of component values, the plurality of transmission values including a set of sections of transmission values, wherein each section of transmission values includes a combination of multiple sections of component values, the transmission values being sufficient to reconstruct some or all of the component values;
forming a series of transmission units from the transmission values, each transmission unit including a plurality of modulation values represents at least one section of transmission values; and
modulating the modulations values of the transmission units to form a transmission signal for transmission over a communication medium, each modulation component of the transmission signal corresponding to a different one of the modulation values, and a magnitude of each modulation component being a monotonic function of the corresponding modulation value such that a degree of degradation of the component values represented in the transmission signal is substantially continuously related to a degree of degradation of the modulation components of the transmission signal.

2. The method of claim 1 further comprising, at a first receiver:
demodulating the transmission signal after transmission over the communication medium to form first estimates of the transmission values;
estimating the component values for the components of each of the plurality of parts of the signal from the estimated transmission values; and
reconstructing an estimate of the input signal from the estimated component values.

3. The method of claim 2 wherein at least some of the transmission units are not received at the first receiver, and the estimate of the signal is reconstructed using the estimates of the transmission values in the received transmission units.

4. The method of claim 2 further comprising, at a second receiver:
demodulating the transmission signal after transmission over the communication medium to form second estimates the transmission values, the second estimates of the transmission values representing substantially greater error than the first estimates formed at the first receiver;
estimating the component values for the components of each of the plurality of parts of the signal from the estimated transmission values; and
reconstructing an estimate of the signal from the estimated component values, the estimate of the input signal representing substantially greater error than the estimate formed at the first receiver.

5. The method of claim 1 further comprising receiving the transmission signal at a plurality of receivers, each received signal exhibiting a different degree of degradation, and forming an estimate of the signal at each receiver, the estimate at each receiver exhibiting an error that is substantially continuously related to the degree of degradation of the received signal.

6. The method of claim 1 wherein each transmission value in a section of transmission values is a monotonic function of component values in multiple sections of component values.

7. The method of claim 6 wherein each transmission value in a section of transmission values is a linear function of component values in multiple sections of component values.

8. The method of claim 7 wherein forming the plurality transmission values from the plurality of component values comprises scaling the component values in each section of component values according to a scale factor associated with that section, and applying an orthogonal transform to the scaled component values.

9. The method of claim 8 wherein the orthogonal transform comprises a Hadamard transform.

10. The method of claim 1 wherein forming the plurality transmission values is such that each section of transmission values has a substantially equal power measure.

11. The method of claim 1 forming a plurality transmission values from the plurality of component values comprises forming scaled component values by scaling the component values in each section according to a scale factor determined according to a power measure associated with that section, and combining the sections of scaled component values to form the sections of transmission values.

12. The method of claim 11 wherein the sections of scaled component values have different power measures.

13. The method of claim 11 wherein the scaled factor determined according to a power measure associated with a section is inversely proportional to a fourth root of a variance of the component values in the section.

14. The method of claim 1 wherein forming a series of transmission units from the transmission values includes determining the modulation values in each transmission unit to have substantially identical statistical characteristic.

15. The method of claim 14 wherein forming a transmission unit includes applying an orthogonal transformation to transmission value to form the modulation values of the transmission unit.

16. The method of claim 1 wherein forming the plurality transmission values from the plurality of component values includes forming ancillary data required for reconstructing the component values from the sections of transmission values.

17. The method of claim 16 wherein the ancillary data represents scale factors for the sections of the component values, and wherein forming the transmission values includes scaling each section of the component values and applying an orthogonal transform to the scaled component values to determine the transmission values.

18. The method of claim 1 wherein the input signal comprises a series of image frames, and each part of the signal comprises a frame of the series.

19. The method of claim 18 wherein the components of the part of the signal comprise Discrete Cosine Transform (DCT) components.

20. The method of claim 19 wherein each frame is comprised of a plurality of blocks, and the DCT components comprise DCT coefficients of the blocks of the image.

21. The method of claim 20 wherein each section of component values for a part of the input signal comprises a DCT coefficient value for multiple blocks of the image and on DCT coefficient.

22. The method of claim 18 wherein each part of the signal comprises a plurality of frames of the series.

23. The method of claim 22 wherein components of the part of the signal comprise coefficient values of a three-dimensional orthogonal transform of the part of the signal, three dimensions of the transform including a time dimension and two spatial dimensions.

24. The method of claim 23 wherein the orthogonal transform comprises a three-dimensional DCT.

25. The method of claim 23 wherein each section of component values for a part of the input signal comprises a transform coefficient value a contiguous range of temporal and spatial frequency coefficients.

26. The method of claim 25 wherein each section of component values consists of a coefficient for a single temporal frequency.

27. The method of claim 1 wherein forming the plurality of transmission values includes scaling component values for a same component in different parts of the signal according to a power measure of said component values.

28. The method of claim 27 wherein the distribution of the component values comprises a sample power measure over a plurality of parts of the signal.

29. The method of claim 1 wherein forming the component values includes forming the component values such that component values corresponding to different components are substantially uncorrelated.

30. The method of claim 1 wherein forming the transmission values includes applying an orthogonal transformation to the component values for components of each part of the signal.

31. The method of claim 1 wherein forming the transmission values includes distributing the component values to transmission values according to a sequence.

32. The method of claim 32 wherein the sequence comprises a pseudo-random sequence known to a receiver of the transmission signal.

33. The method of claim 1 wherein forming the transmission values and assembling the transmission values into transmission units is such that a power measure of each transmission unit is substantially equal to the power measure for the other transmission units.

34. The method of claim 1 wherein forming the transmission units is such that an impact of loss of any packet has a substantially equal impact on reconstruction error at a receiver.

35. The method of claim 34 wherein the impact of loss of any packet has a substantially equal impact on a mean squared error measure of the reconstructed signal.

36. The method of claim 1 wherein modulating the transmission values includes applying an Orthogonal Frequency Division Multiplexing (OFDM) technique in which each transmission value corresponds to a modulation component comprising a quadrature component of a frequency bin of the transmission signal.

37. The method of claim 1 wherein forming the transmission values includes selecting a number of transmission values according to an available capacity of the communication medium for transmission of the modulated signal.

38. The method of claim 1 wherein forming the transmission values includes selecting a number of transmission values according to a degree of degradation of the modulated signal.

39. The method of claim 1 wherein the transmission medium comprises a shared access wireless medium.

40. A method for communicating over a shared access medium comprising:
providing an interface for accepting transmission units each including a data payload from a communication application, and accepting an indication whether a data payload of the transmission unit should be transmitted using a digital coding of the data payload or using a monotonic transformation of values in the data payload to magnitudes of modulation components in a transmission signal;
forming signal representations of the transmission units according to accepted indications; and
transmitting a plurality of transmission units onto the shared medium, including transmitting at least some of said units using a digital coding of the data payload of the unit and at least some of said units using a monotonic transformation of values to modulation components.

41. The method of claim 40 wherein the signal representations comprise OFDM modulations of values, and wherein the modulation components comprise quadrature components of frequency bins of the transmission signal.

42. A communication system comprising a transmitter for communicating an input signal, the transmitter comprising:
a compression module for forming a plurality of component values for components for the part of the signal, the plurality of component values being partitioned into a set of sections of component values;
an error protection module for forming a plurality transmission values from the plurality of component values, the plurality of transmission values including a set of sections of transmission values, wherein each section of transmission values includes a combination of multiple sections of component values, the transmission values being sufficient to reconstruct some or all of the component values;
a packetization module for forming a series of transmission units from the transmission values, each transmission unit including a plurality of modulation values represents at least one section of transmission values; and
a modulation module for modulating the modulations values of the transmission units to form a transmission signal for transmission over a communication medium, each modulation component of the transmission signal corresponding to a different one of the modulation values, and a magnitude of each modulation component being a monotonic function of the corresponding modulation value such that a degree of degradation of the component values represented in the transmission signal is substantially continuously related to a degree of degradation of the modulation components of the transmission signal.

43. The communication system of claim 42 further comprising a plurality of receivers, each receiver comprising:
a demodulation module for demodulating the transmission signal after transmission over the communication medium to form first estimates of the transmission values;
an estimation module for estimating the component values for the components of each of the plurality of parts of the signal from the estimated transmission values; and
a reconstruction module for reconstructing an estimate of the input signal from the estimated component values.

44. A communication system comprising a receiver for communicating a signal encoded in a received transmission signal, the receiver comprising:
a demodulation module for digital demodulation of digitally encoded metadata and analog demodulating transmission values in a transmission signal, such the analog demodulated transmission values exhibit degradation such that a degree of degradation of the transmission values represented in the transmission signal is substantially continuously related to a degree of degradation of the modulation components of the transmission signal; and
an estimation module configured to determine a plurality of scaling factors from the demodulated metadata, and using the scaling factors and an estimate of a noise level of the received transmission signal to estimate a plurality of component values of the communicated signal from the demodulated transmission values.

45. A method for delivering connect over a channel, the method comprising:
accepting a content signal comprising a plurality of content values; and
transforming the content signal to form a transmission signal comprising a plurality of transmission values, the transmission signal representing a plurality of degrees of compression of the content signal;
wherein the transmission values are monotonically related to the content values such that perturbations of the transmission values correspond to perturbations of the content values.
